(19) United States
(12) Patent Application Publication
(10) Pub. No.: US 2012/0107447 A1
(43) Pub. Date: May 3, 2012

(54) PLASTIC INJECTION MOLD

(75) Inventors: JIAN-MING LI, Tu Cheng (TW); Xiao-ping Wu, Tu Cheng (TW); Shih-hsiung Ho, Tu Cheng (TW)

(73) Assignee: Cheng Uei Precision Industry Co., LTD., Tu Cheng City (TW)

(21) Appl. No.: 12/916,585

(22) Filed: Oct. 31, 2010

(51) Int. Cl. B29C 45/40

(52) U.S. Cl. 425/556

(57) ABSTRACT

A plastic injection mold includes a female mold, a male mold mateable with the female mold, and two ejection mechanisms. The ejection mechanisms are coupled to the ejector plate. Each ejection mechanism includes a slanted ejector lever and a hook portion projecting sideways from one end of the slanted ejector lever. When a product has hook like portions is molded with the injection mold, the slanted ejector levers are movable in both horizontal and vertical directions at the same time to help easily releasing the molded product from the mold thereby improving production efficiency.

### TECHNICAL FIELD OF THE INVENTION

The present invention relates to a mold, and especially to a plastic injection mold.

### BACKGROUND OF THE INVENTION

Referring to FIG. 4, a conventional plastic injection mold 80 comprises a male mold 81 and a female mold 82. The male mold 81 comprises a male mold fixing plate 811, a male mold platen 812, an ejector plate 813, an ejector retainer plate 814, a plurality of ejector pins 815, and a mold core 816 which is disposed on the male mold platen 812. The ejector pins 815 are disposed on the ejector plate 813. The ejector retainer plate 814 fixes one end of each ejector pin 815, and the other end of the ejector pin 815 is inserted into the mold core 816.

However, when a tubular product has a hook like portion on an inside wall thereof, the tubular product can not be released from the mold by a normally straight ejector pin for the hook like portion may cause jamming of the molded product in the mold. It is thus often needed to manually release the tubular product, and it is not helpful to increase productivity.

### SUMMARY OF THE INVENTION

An objective of the present invention is to provide a plastic injection mold to overcome the drawbacks of the above-mentioned prior art.

To achieve the foregoing objective, a plastic injection mold comprises a female mold, a male mold which is mateable with the female mold, and two ejection mechanisms. The male mold comprises a male mold platen, an ejector plate which opposes the male mold platen, and a mold core which is disposed on the male mold platen. Two slanted holes are defined in the mold core. The ejection mechanisms are coupled to the ejector plate. Each ejection mechanism comprises a slanted ejector lever, which has one end forming a sideways projecting hook portion. The slanted ejector levers are respectively and slidably received in the slanted holes of the mold core and partially project out of the mold core. A molding cavity is defined by the hook portion of each slanted ejector lever and an end surface of the mold core for forming a corresponding hook like portion of a product molded with the injection mold.

In summary, the present invention provides a plastic injection mold that is provided with ejection mechanisms arranged in a male mold. Thus, when an inside wall of a product to be molded with the plastic injection mold has a hook or barb like portion, a slanted ejector lever of each ejection mechanisms is movable in both horizontal and vertical directions at the same time for releasing and thus ejecting the molded product, thereby making the molded product successfully released from the mold without undesired jamming to improve production efficiency.

### BRIEF DESCRIPTION OF THE DRAWINGS

FIG. 1 is a cross-sectional view illustrating a plastic injection mold after mold closing according to the present invention;

FIG. 2 is a cross-sectional view illustrating a plastic injection mold after mold releasing according to the present invention;

FIG. 3 is an exploded illustrating an ejection mechanism of the plastic injection mold according to FIG. 2; and

FIG. 4 is cross-sectional view illustrating a conventional plastic injection mold after mold closing.

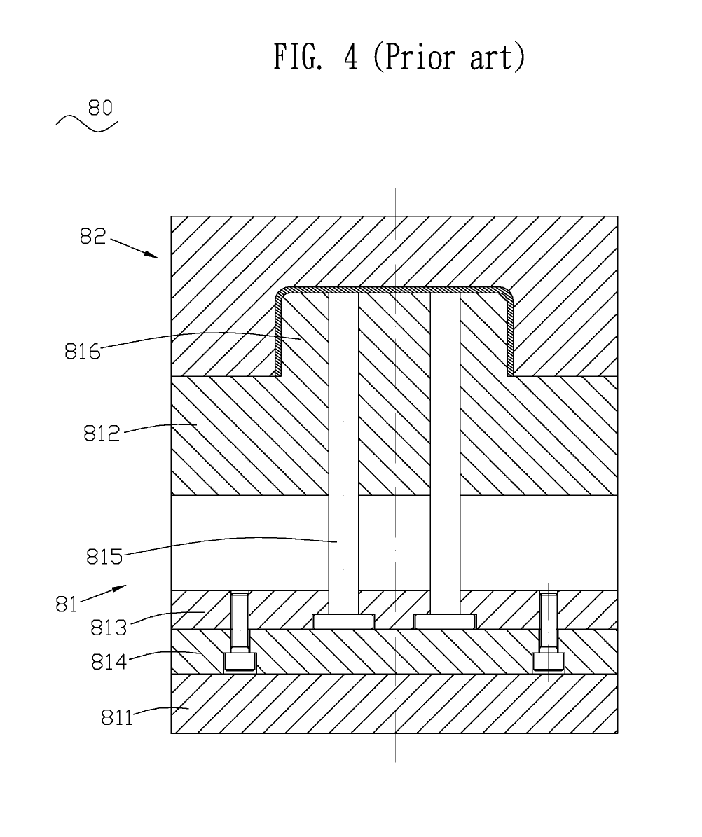

### DETAILED DESCRIPTION OF THE PREFERRED EMBODIMENT

Reference will now be made in detail to a preferred embodiment of the invention, examples of which are illustrated in the accompanying drawings.

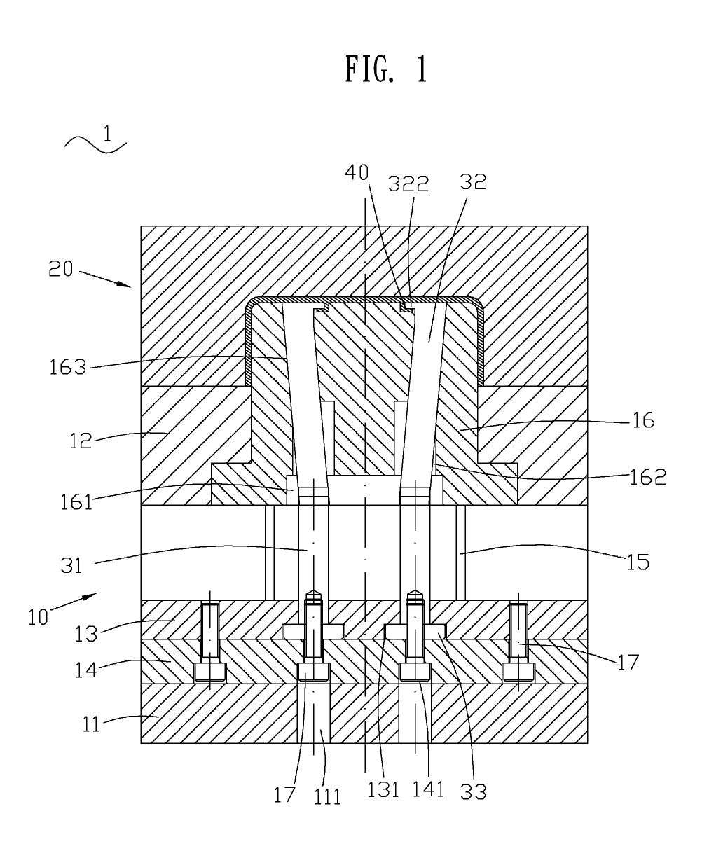

Referring to FIG. 1, a plastic injection mold 1 of the present invention comprises a male mold 10, a female mold 20 and two ejection mechanisms 30 fixed on the male mold 10.

The male mold 10 comprises a male mold fixing plate 11, a male mold platen 12, an ejector plate 13, an ejector retainer plate 14, a plurality of ejector pins 15 and a mold core 16 which is disposed on the male mold platen 12. The ejector retainer plate 14 is disposed above the male mold fixing plate 11, and the ejector plate 13 is fixed on the ejector retainer plate 14. The male mold platen 12 is disposed above the ejector plate 13 at a distance apart, so that the ejector plate 13 and the ejector retainer plate 14 are moveable between the male mold fixing plate 11 and the male mold platen 12. Two passage holes 111 are defined in the male mold fixing plate 11; two holding holes 131 are defined in the ejector plate 13; and two connection holes 141 are defined in the ejector retainer plate 14, where the connection holes 141, the holding holes 131 and the passage holes 111 are interconnecting with and communicating each other. The ejector pins 15 are fixed on the ejector plate 13. The mold core 16 forms a receiving slot 161 and two circular receiving holes 162 which are connected to and communicate the receiving slot 161, and two slanted holes 163 which are connected to and communicate the receiving holes 162. The size of the receiving hole 162 is greater than the size of the slanted hole 163.

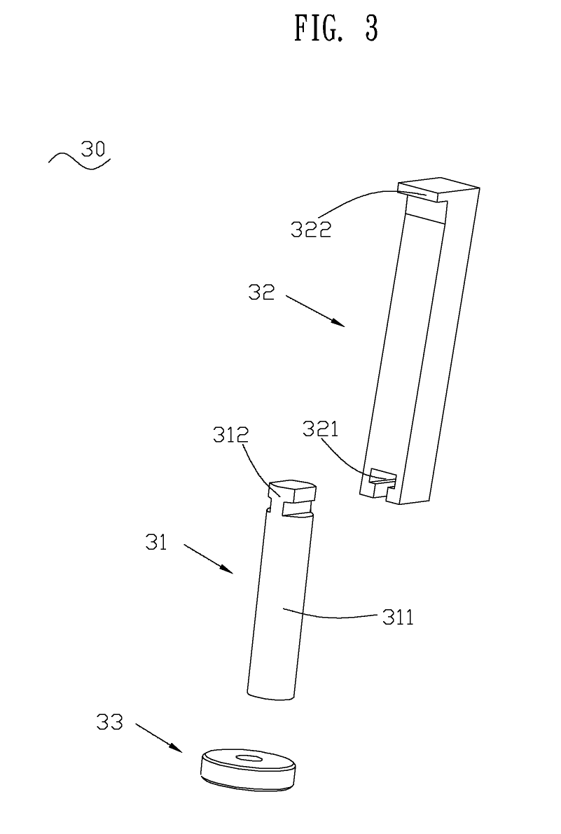

Referring to FIGS. 1 and 3, each of the ejection mechanisms 30 comprises a vertical ejector lever 31, a slanted ejector lever 32 which is connected to one end of the vertical ejector lever 31, and a spacer 33 which is arranged at an opposite end of the vertical ejector lever 31. The vertical ejector lever 31 has a circular plinth 311 and a T-shaped connection block 312 protruding from one end of the circular plinth 311. The diameter of the circular plinth 311 is smaller than the diameter of the receiving hole 161. A T-shaped connection slot 321 is defined in one end of the slanted ejector lever 32, and a hook portion 322, which projects sideways, is formed on the other end of the slanted ejector lever 32. The T-shaped connection block 312 of the vertical ejector lever 31 is slidably receivable in the T-shaped connection slot 321 of the slanted ejector lever 32 to form a movable coupling therebetween.

Referring to FIG. 1, to assemble the plastic injection mold 1, the mold core 16 is positioned on the male mold platen 12. The slanted ejector levers 32 of the ejection mechanisms 30 are respectively inserted into the receiving holes 162 and the associated slanted holes 163 of the mold core 16 to partially project out of the mold core 16, whereby a molding cavity 40 is defined by the hook portion 322 of each of the slanted ejector levers 32 and an end surface of the mold core 16 for molding a hook or barb-like portion of a molded product. The vertical ejector lever 31 of each of the ejection mechanisms 30 is coupled to the respective slanted ejector lever 32 by having the T-shaped connection block 312 of the vertical ejector lever 31 received in the T-shaped connection slot 321 of the slanted ejector lever 32. The ejector pins 15 and the vertical ejector levers 31 are then inserted into the ejector plate 13, and the spacers 33 are respectively set in the holding holes 131 of the ejector plate 13. Afterwards, the ejector retainer plate 14 is fastened to the ejector plate 13 by fastening screws 17 that are respectively received in the connection holes 141 of the ejector retainer plate 14. The fastening screws 17 engage and thus fix the vertical ejector levers 31 of the ejection mechanisms 30, the spacers 33, and the ejector retainer plate 14 together. Furthermore, the passage holes 111, which are defined in the male mold fixing plate 11, the connection holes 141, and the holding holes 131 are interconnected with and communicate each other, whereby the fastening screws 17 can be loosened to separate the vertical ejector levers 31 and the associated spacers 33 without disassembling the ejector plate 13 and the ejector retainer plate 14. This allows the vertical ejector levers 31 to be removed and replaced quickly. The fastening screws 17, which are of a sufficient number, are set in the ejector plate 13 and the ejector retainer plate 14 for fixing them together.

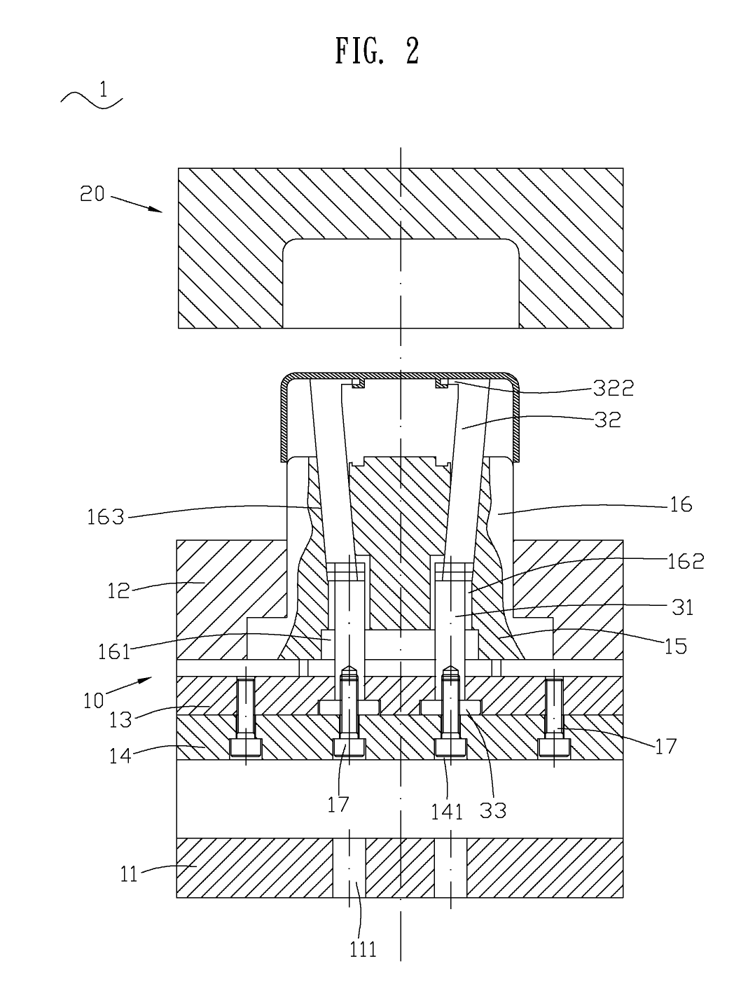

Referring to FIG. 2, when the plastic injection mold 1 is released, namely in an ejection phase, the vertical ejector levers 31 of the ejection mechanisms 30 move upward in the vertical direction for ejection. Since the vertical ejector levers 31 and the slanted ejector levers 32 are movably coupled to each other, the slanted ejector levers 32 are caused to move along the slanted hole 163 in an oblique manner to eject the molded product when the vertical ejector levers 31 extend into the receiving hole 162. In the ejection process, the hook portions 322 of the slanted ejector levers 32 depart from the molded product to allow the molded product that has barb-like portions to be ejected without undesired jamming.

As mentioned above, the present invention provides a plastic injection mold 1 that is provided with ejection mechanisms 30 arranged in a male mold 10. Thus, when an inside wall of a product to be molded with the plastic injection mold 1 has a hook or barb like portion, a slanted ejector lever 32 of each ejection mechanism 30 is movable in both horizontal and vertical directions at the same time for releasing and thus ejecting the molded product, thereby making the molded product successfully released from the mold without undesired jamming to improve production efficiency.

While the preferred embodiment of the present invention has been illustrated and described in detail, various modifications and alterations can be made by persons skilled in this art. For example, the method to couple the slanted ejector lever and the vertical ejector lever can be a rivet joint or directly mounting the slanted ejector lever on the ejector plate. All the modifications and alterations should be covered in the appended claims.

What is claimed is:

1. An injection mold, comprising:
a female mold;
a male mold, which is mateable with the female mold, the male mold comprising a male mold platen, an ejector plate opposing the male mold platen, and a mold core disposed on the male mold platen, a slanted hole being defined in the mold core; and
an ejection mechanism, which is coupled to the ejector plate, the ejection mechanism comprising a slanted ejector lever, which has one end forming a sideways projecting hook portion, the slanted ejector lever being slidably received in the slanted hole of the mold core and partially projecting out of the mold core, a molding cavity being defined by the hook portion and an end surface of the mold core for molding a hook portion of a product that is molded with the injection mold.

2. The injection mold of claim 1, wherein the mold core forms therein a receiving slot and a receiving hole communicating the receiving slot, the receiving hole being in communication with the slanted hole, and the slanted ejector lever being movably inserted into the receiving slot, the receiving hole, and the slanted hole.

3. The injection mold of claim 1, wherein the ejection mechanism comprises a vertical ejector lever, one end of which is movably coupled to the slanted ejector lever and an opposite end is fixed on the ejector plate.

4. The injection mold of claim 3, wherein the vertical ejector lever comprises a circular plinth and a T-shaped connection block protruding from one end of the circular plinth, a T-shaped connection slot being defined in one end of the slanted ejector lever and slidably receiving the T-shaped connection block therein.

5. The injection mold of claim 1, wherein the male mold comprises a male mold fixing plate, an ejector retainer plate, and a plurality of ejector pins, a passage hole being defined in the male mold fixing plate, a holding hole being defined in the ejector plate, a connection hole being defined in the ejector retainer plate, the connection hole, the holding hole, and the passage hole interconnecting and communicating each other.

6. The injection mold of claim 5, wherein a spacer is received in the holding hole, and the spacer is coupled to one end of the vertical ejector lever.

7. The injection mold of claim 5, wherein a fastening screw is respectively received in the connection hole of the ejector retainer plate to engage and thus fix the vertical ejector lever of the ejection mechanism, the spacer, and the ejector retainer plate together.
